(19) United States
(12) Patent Application Publication
(10) Pub. No.: US 2025/0092686 A1
(43) Pub. Date: Mar. 20, 2025

(54) BUILDING SURFACE PRODUCT INCLUDING PRESS-IN FASTENER, BUILDING SURFACE SYSTEM, AND METHOD OF MANUFACTURE

(71) Applicant: CERTAINTEED LLC, Malvern, PA (US)

(72) Inventors: Colton MARSHALL, Auburn, MA (US); Kenneth Keefer, Westford, MA (US); James LaLone, Worcester, MA (US); Sara A. Barrows, Cambridge, MA (US); Natalia H. Thomas, Worcester, MA (US); Hooman Amid, Worcester, MA (US)

(21) Appl. No.: 18/884,388

(22) Filed: Sep. 13, 2024

Related U.S. Application Data
(60) Provisional application No. 63/582,915, filed on Sep. 15, 2023.

(51) Int. Cl. E04F 13/08

(52) U.S. Cl. CPC E04F 13/0835

(57) ABSTRACT

The present disclosure relates to a building surface product that may include a substantially planar panel having a front surface, a rear surface, a first side, a second side, a first end, a second end, a gypsum body between the front surface and rear surface, and a first press-in fastener positioned on the rear surface of the substantially planar panel. The first press-in fastener may include a mending plate portion that may include a plurality of prongs inserted into the rear surface of the substantially planar panel, and a support structure attachment portion.

### CROSS-REFERENCE TO RELATED APPLICATION(S)

This application claims priority under 35 U.S.C. § 119 (e) to U.S. Provisional Patent Application No. 63/582,915, entitled “BUILDING SURFACE PRODUCT INCLUDING PRESS-IN FASTENER, BUILDING SURFACE SYSTEM, AND METHOD OF MANUFACTURE,” filed Sep. 15, 2023, by Colton MARSHALL et al., which is assigned to the current assignee hereof and is incorporated herein by reference in its entirety.

### FIELD OF THE DISCLOSURE

The present disclosure relates generally to building surface systems, for example, suitable for forming an internal or external surface of a building. The present disclosure relates more particularly to a building surface product including a press-in fastener.

### BACKGROUND

Prefabricated panels, for example gypsum panels that are commonly referred to as drywall, are often used to construct building surfaces. The panels can be attached to a supporting structure, such as the joists of a wall frame. Once the panels are hung on the supporting structure, the surface can be finished using joint compound or another material to create a smooth surface. The surface may then be painted or covered with wallpaper.

Gypsum panels may be advantageous for use as a building surface for various reasons. Such panels may be incredibly durable, may have excellent fire resistance, may be easily repaired, and may be easily mounted on a supporting structure. Typically, mounting gypsum panels only requires attaching the panels to an underlying supporting structure using mechanical fasteners, such as screws.

While mounting gypsum panels can be straightforward, most panels are finished by covering the joints between the panels and the fasteners in order to create a smooth surface. The panels may then be painted or covered with wallpaper to create a pleasing aesthetic. The process of finishing the building surface can be time consuming, as each application of joint compound or paint should be dried before the subsequent step can be performed. Moreover, the finishing steps require uncommon skills. For these reasons, a building surface product that can be installed more quickly is desirable.

### SUMMARY

According to a first aspect, a building surface product may include a substantially planar panel having a front surface, a rear surface, a first side, a second side, a first end, a second end, a gypsum body between the front surface and rear surface, and a first press-in fastener positioned on the rear surface of the substantially planar panel. The first press-in fastener may include a mending plate portion that may include a plurality of prongs inserted into the rear surface of the substantially planar panel, and a support structure attachment portion.

According to another aspect, a support structure may include a plurality of framing members that form a support surface, a first building surface product attached to the support structure; and a second building surface product attached to the support structure and positioned adjacent to the first building surface product. The first building surface product may include a substantially planar panel having a front surface, a rear surface, a first side, a second side, a first end, a second end, a gypsum body between the front surface and rear surface, and a first press-in fastener positioned on the rear surface of the substantially planar panel. The first press-in fastener may include a mending plate portion that may include a plurality of prongs inserted into the rear surface of the substantially planar panel, and a support structure attachment portion. The second building surface product may also include a substantially planar panel having a front surface, a rear surface, a first side, a second side, a first end, a second end, a gypsum body between the front surface and rear surface, and a first press-in fastener positioned on the rear surface of the substantially planar panel. The first press-in fastener may include a mending plate portion that may include a plurality of prongs inserted into the rear surface of the substantially planar panel, and a support structure attachment portion.

According to still another aspect, a method of forming the building surface system may include positioning a first building surface product against a support structure, securing the first building surface product to the support structure, position the second building surface product against the support structure and adjacent to the first building surface product, and securing the second building surface product to the support structure. The first building surface product may include a substantially planar panel having a front surface, a rear surface, a first side, a second side, a first end, a second end, a gypsum body between the front surface and rear surface, and a first press-in fastener positioned on the rear surface of the substantially planar panel. The first press-in fastener may include a mending plate portion that may include a plurality of prongs inserted into the rear surface of the substantially planar panel, and a support structure attachment portion. The second building surface product may also include a substantially planar panel having a front surface, a rear surface, a first side, a second side, a first end, a second end, a gypsum body between the front surface and rear surface, and a first press-in fastener positioned on the rear surface of the substantially planar panel. The first press-in fastener may include a mending plate portion that may include a plurality of prongs inserted into the rear surface of the substantially planar panel, and a support structure attachment portion.

### BRIEF DESCRIPTION OF THE DRAWINGS

Embodiments are illustrated by way of example and are not limited to the accompanying figures.

FIG. 1A includes an illustration of a schematic perspective view of a building surface product according to an embodiment described herein;

FIG. 1B includes an illustration of a schematic front view of a portion of the building surface product of FIG. 1A according to an embodiment described herein;

FIG. 1C includes an illustration of a schematic cross-sectional view of a portion of the building surface product of FIG. 1A according to an embodiment described herein;

FIG. 1D a schematic perspective view of a press-in fastener according to an embodiment described herein;

FIG. 1E a schematic perspective view of a press-in fastener according to an embodiment described herein;

FIG. 2A is a schematic perspective view of a building surface system according to an embodiment described herein; and

FIG. 2B includes an illustration of a schematic cross-sectional view of a portion of the building surface system of FIG. 2A according to an embodiment described herein.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to a building surface product that may include a substantially planar panel having a front surface, a rear surface, a first side, a second side, a first end, a second end, a gypsum body between the front surface and rear surface, and a first press-in fastener positioned on the rear surface of the substantially planar panel. The first press-in fastener may include a mending plate portion that may include a plurality of prongs inserted into the rear surface of the substantially planar panel, and a support structure attachment portion.

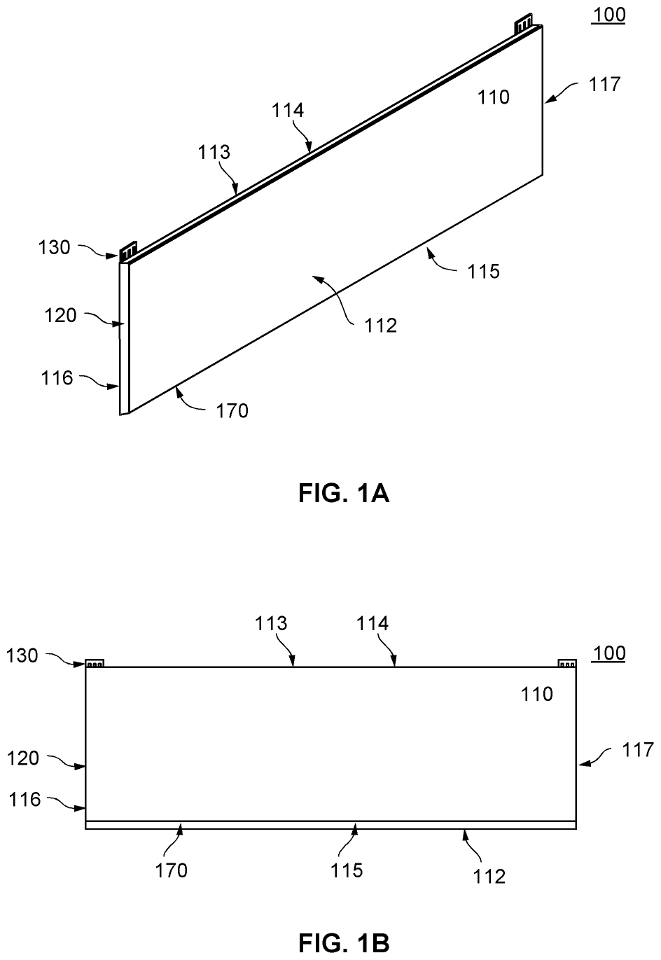

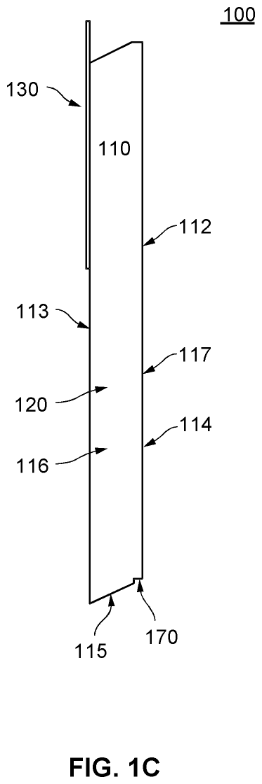

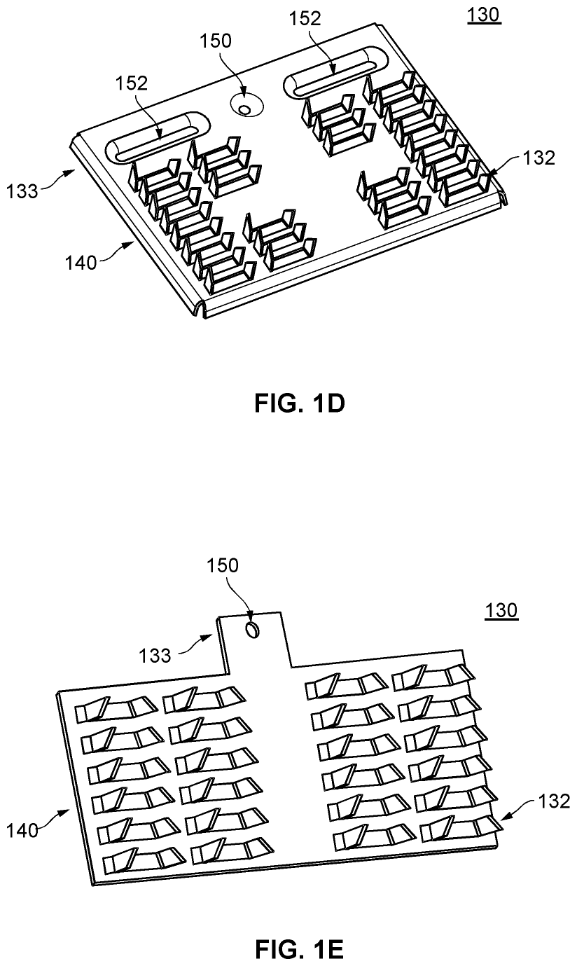

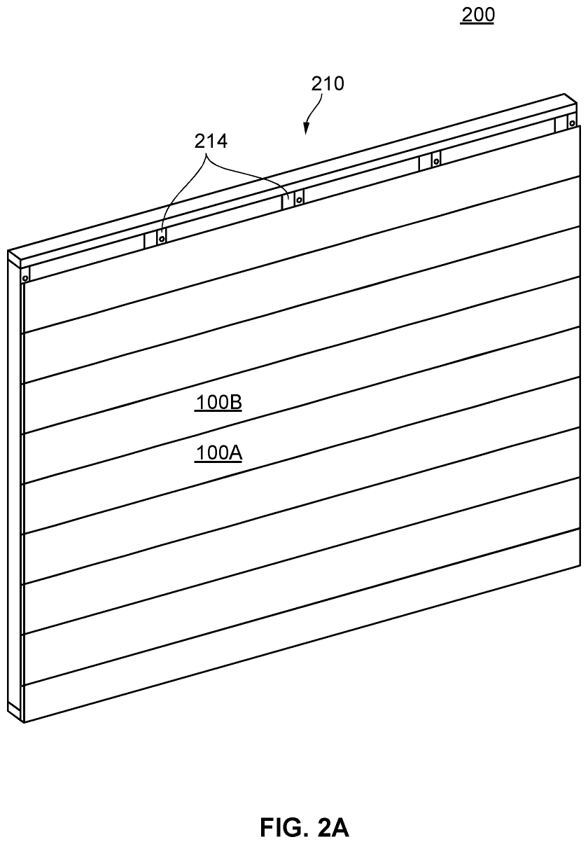

For purposes of illustration, FIGS. 1A, 1B and 1C show various schematic views of a building surface product 100 according to embodiments described herein.

FIG. 1A shows a schematic perspective view of the building surface product 100 according to embodiments described herein. As shown in FIG. 1A, a building surface product 100 may include a substantially planar panel 110. According to certain embodiments, and as shown in FIG. 1A, the substantially planar panel 110 may have a front surface 112, a rear surface 113, a first side 114, a second side 115, a first end 116, and a second end 117. According to still other embodiments, and as shown in FIG. 1A, the substantially planar panel 110 may include a gypsum body 120 between the front surface 112 and rear surface 113. According to yet other embodiments, and as shown in FIG. 1A, the building surface product 100 may further include a press-in fastener 130 positioned on the rear surface 113 of the substantially planar panel 110.

FIG. 1B shows a schematic front view of the building surface product 100 according to embodiments described herein. As shown in FIG. 1B, the building surface product 100 may include the substantially planar panel 110. According to certain embodiments, and as shown in FIG. 1B, the substantially planar panel 110 may have the front surface 112, the rear surface 113, the first side 114, the second side 115, the first end 116, and the second end 117. According to still other embodiments, and as shown in FIG. 1B, the substantially planar panel 110 may include the gypsum body 120 between the front surface 112 and rear surface 113. According to yet other embodiments, and as shown in FIG. 1B, the building surface product 100 may further include a press-in fastener 130 positioned on the rear surface 113 of the substantially planar panel 110.

FIG. 1C shows a schematic cross-sectional view of the building surface product 100 according to embodiments described herein. As shown in FIG. 1C, the building surface product 100 may include the substantially planar panel 110. According to certain embodiments, and as shown in FIG. 1C, the substantially planar panel 110 may have the front surface 112, the rear surface 113, the first side 114, the second side 115, the first end 116, and the second end 117 (not shown). According to still other embodiments, and as shown in FIG. 1C, the substantially planar panel 110 may include the gypsum body 120 between the front surface 112 and rear surface 113. According to yet other embodiments, and as shown in FIG. 1C, the building surface product 100 may further include a press-in fastener 130 positioned on the rear surface 113 of the substantially planar panel 110.

According to certain embodiments, the press-in fastener press-in fastener 130 may include a mending plate portion that may include a plurality of prongs, and a support structure attachment portion.

For purposes of illustration, FIGS. 1D and 1E show schematic perspective views of embodiments of press-in fastener 130.

According to a particular embodiment, and as shown in FIG. 1D, a press-in fastener 130 may include a mending plate portion 132 and a support structure attachment portion 133. According to yet another embodiment, and as shown in FIG. 1D, the mending plate portion 132 may include prongs 140. According to still other embodiments, and as shown in FIG. 1D, the support structure attachment portion 133 may be configured to facilitate attachment of the press-in fastener 130 to a structure (not shown). According to a particular embodiment, and as shown in FIG. 1D, the support structure attachment portion 133 may include a hanging hole 150. According to still other embodiments, the support structure attachment portion 133 may include multiple hanging holes 150 (not shown) arranged to facilitate hanging of the press-in fastener. According to still other embodiments, the support structure attachment portion 133 may further include at least one slot 152 adjacent to the hanging hole 152. According to alternative embodiments, and as shown in FIG. 1D, the support structure attachment portion 133 may further include at least two slots 152 arranged such that the hanging hole 152 is between the two slots 152.

It will be appreciated that the hanging hole 150 may have any desirable shape, for example, any desirable shape that will allow a mechanical fastener, such as a screw or a nail, to pass through the hole and fasten the support structure attachment portion 133 to a support structure. For example, the hanging hole 150 may be a circle, an oval, or a square. According to still other embodiments, the hanging hole 150 may be elongated in a particular direction. According to still other embodiments, the hanging hole 150 may be any size. According to still other embodiments, the hanging hole 150 may have a countersink configuration (i.e., have curved edges at one surface of the support structure attachment portions 133, where the curved edges are configured to receive a countersunk head of a mechanical fastener, such that, when installed, the countersunk head of a mechanical fastener is flush with a surface of the support structure attachment portion 133). It will be further appreciated that any slot 152 described herein may have any desirable shape, for example, any desirable shape that will allow a mechanical fastener, such as a screw or a nail, to pass through the slot 152 and fasten the support structure attachment portion 133 to a support structure. For example, the slot 152 may be a circle, an oval, or a square. According to still other embodiments, the hole may be elongated in a particular direction. According to still other embodiments, the slot 152 may be any size. It will be further appreciated that a slot 152 may be distinct from a hanging hole 150 in that it has a more elongated shape in a particular direction.

According to another embodiment, and as shown in FIG. 1E, a press-in fastener 130 may include a mending plate portion 132 and a support structure attachment portion 133. According to yet another embodiment, and as shown in FIG. 1E, the mending plate portion 132 may include prongs 140. According to still other embodiments, and as shown in FIG. 1E, the support structure attachment portion 133 may include a tab extending out from the mending plate portion 132 and having a hanging hole 150 within the tab.

According to yet other embodiments, the structure attachment portion 133 of the press-in fastener 130 may include an adhesive configured to attach structure attachment portion 133 to a structure. According to certain embodiments, the adhesive may be used where the structure attachment portion 133 of the press-in fastener 130 has no holes (i.e., the adhesive is the sole component for attaching the structure attachment portion 133 of the press-in fastener 130 to a structure), or where the structure attachment portion 133 of the press-in fastener 130 has holes and/or slots (i.e., the adhesive is an additional component for attaching the structure attachment portion 133 of the press-in fastener 130).

According to certain embodiments, as shown in FIGS. 1A-1C, the press-in fastener 130 be attached to the panel 110 such that the mending plate portion is attached to the rear surface 113 of the panel 110 via the prongs 140 extending into the panel 110. According to still other embodiments, the support structure attachment portion 133 of the press-in fastener 130 may extend above a top edge of the rear surface 113 of the panel 110 such that the support structure attachment portion 133 is not covered by the panel 110.

According to still other embodiments, and as shown in FIGS. 1A-1C, the first side 114 of panel 110 may be positioned at the top of the panel 110 such that a top projection of the panel 110 is on the top of the panel 110. According to other embodiments, the second side 115 of the panel may be positioned at the bottom of the panel 110 such that a bottom projection opposite of the top projection of the panel 110 is on the bottom of the panel 110.

According to particular embodiments, the top projection on the first side 114 may have an angled rear face and the bottom projection on the second side 115 may have an angled front face. For example, and as shown in FIGS. 1A-1C, in the building surface product 100, the first side 114 may be formed of an angled face extending down from an upward extension of the front surface 112 to the rear surface 113. Likewise, the second side 115 may be formed of an angled face extending up from a downward extension of the rear surface 113 to the front surface 112. According to certain embodiments, the top projection on the first side 114 may be described as having an angled rear face and the bottom projection on the second side 115 may be described as having an angled front face. According to still other embodiments, the first side 114 and second side 115 may have complementary angles to one another in order to be able to receive future additional panels above and below. As such, it will be understood that in some embodiments, the top projection on the first side 114 may have an angled front face and the bottom projection on the second side 115 may have an angled rear face. Also, in some embodiments (not pictured), the angles of both first and second sides on a given panel 110 may both be angled to the front or to the rear.

According to still other embodiments the building surface product 100 as otherwise described herein, may include a portion of the panel extending from a centerline of the panel to the second side 115 of the panel 110 that is free of fasteners (i.e., a fastener is not attached to the front surface 112 or the rear surface 113 of the panel 110). As explained in more detail below, when installed, the lower portion of the panel 110 may be secured to a support surface by pressing the bottom projection of the panel 110 rearward through engagement with the panel of a neighboring building surface product.

According to still other embodiments, and as shown in FIGS. 1A-1C, the second side 115 may further include an aesthetic gap feature 170 making up the edge where the angles face of the second side 115 intersects with the front surface 112 of the panel 110. According to certain embodiments, the aesthetic gap feature 170 may have a particular depth and height. Again, as explained in more detail below, when installed, the aesthetic gap feature 170 of the panel 110 gives the appearance of a gap between the bottom of the panel and the top of the panel of a neighboring building surface product. According to still other embodiments, the depth and height of the aesthetic gap feature 170 may be varied to modify the appearance of the gap. According to yet other embodiments, the aesthetic gap feature 170 may be filled, before installation or after installation with a functional material, such as, an acoustic damping material, a fire retardant material, a fire resistant material, a moisture barrier material, a water vapor barrier material, a biocidal material, a dimensional stabilizer material, or any combination thereof. According to still other embodiments, the aesthetic gap feature 170 may be filled, before installation or after installation, with a functional component configured to provide any desirable function or design benefit to the structure. For example, the aesthetic gap feature 170 may be filled with a lighting component, such as, an LED component, or the aesthetic gap feature 170 may be filled with a sound component.

According to still other embodiments, the gypsum body 120 of the panel 110 may be formed by a continuous layer of gypsum that extends from the front surface 112 to the rear surface 113. For purposes of embodiments described herein, the phrase continuous layer refers to a structure where adhered gypsum material extends throughout the layer without a gap or separate material extending through the layer. According to other embodiments, the continuous layer may have varying properties of the gypsum material across the layer, such as density or composition. According to still other embodiments, the layer of gypsum may contain reinforcing materials such as scrims that may be common in such structures. Such reinforcement materials may be integral to the structure and be permeated by the gypsum material. According to yet other embodiments, the layer of gypsum may contain a functional material, such as, an acoustic damping material, a fire-retardant material, a fire-resistant material, a moisture barrier material, a water vapor barrier material, a biocidal material, a dimensional stabilizer material, or any combination thereof.

According to still other embodiments, the building surface product 100 as otherwise described herein, may have a particular panel width from the first side 114 to the second side 115. For example, the building product 100 may have a panel width of at least 50 mm, such as, at least about 100 mm or at least about 150 mm or at least about 200 mm or at least about 250 mm or at least about 300 mm or at least about 350 mm or at least about 400 mm or at least about 450 mm or at least about 500 mm or at least about 550 mm or at least about 600 mm or at least about 650 mm or at least about 700 mm or at least about 750 mm or at least about 800 mm or at least about 850 mm or at least about 900 mm or at least about 950 mm or even at least about 1000 mm. According to still other embodiments, the building product 100 may have a panel width of not greater than about 3 meters, such as, not greater than about 2.5 meters or not greater than about 2 meters or not greater than about 1.5 meters or not greater than 1.1 meters. It will be appreciated that the building product 100 may have a panel width within a range between any of the values noted above. It will be further appreciated that the building product 100 may have a panel width of any value between any of the minimum and maximum values noted above.

According to yet other embodiments, the building surface product 100 as otherwise described herein, may have a particular panel length from the first end 116 to the second end 117. For example, the building product 100 may have a panel length of at least 20 mm, such as, at least about 30 mm or at least about 40 mm or at least about 50 mm or at least about 100 mm or at least about 150 mm or at least about 200 mm or at least about 250 mm or at least about 300 mm or at least about 350 mm or at least about 400 mm or at least about 450 mm or at least about 500 mm or at least about 550 mm or at least about 600 mm or at least about 650 mm or at least about 700 mm or at least about 750 mm or at least about 800 mm or at least about 850 mm or at least about 900 mm or at least about 950 mm or at least about 1000 mm or at least about 1050 mm or at least about 1100 mm or at least about 1150 mm or at least about 1200 mm or even at least about 1250 mm. According to still other embodiments, the building product 100 may have a panel length of not greater than about 7 meters, such as, not greater than 6 meters or not greater than about 5 meters or not greater than about 4 meters or not greater than 3 meters. It will be appreciated that the building product 100 may have a panel length within a range between any of the values noted above. It will be further appreciated that the building product 100 may have a panel length of any value between any of the minimum and maximum values noted above.

According to other embodiments, the building surface product 100 as otherwise described herein, may have a particular panel thickness from the front surface 112 to the rear surface 113. For example, the building product 100 may have a panel thickness of at least 5 mm, such as, at least about 10 mm or at least about 15 mm or at least about 20 mm or at least about 25 mm or at least about 30 mm or at least about 35 mm or at least about 40 mm or at least about 45 mm or even at least about 50 mm. According to still other embodiments, the building product 100 may have a panel thickness of not greater than about 100 mm, such as, not greater than 90 mm or not greater than about 80 mm or not greater than about 70 mm or not greater than 60 mm. It will be appreciated that the building product 100 may have a panel thickness within a range between any of the values noted above. It will be further appreciated that the building product 100 may have a panel thickness of any value between any of the minimum and maximum values noted above.

In certain embodiments of the building surface product as otherwise described herein, the gypsum body comprises a reinforced gypsum material. The use of a reinforced gypsum material can enhance the connection between the panel and the attachment posts that are attached to the panel. Moreover, the use of a reinforced gypsum material can also provide extra stability for the panel in the vicinity of the attachment posts. For example, in some embodiments, the gypsum body includes at least 1% by weight polymer. Reference to the weight percentage of a component of the gypsum body, as used herein, refers to the weight after the gypsum has set. In certain embodiments, the polymer includes starch and/or polyvinyl acetate.

In certain embodiments of the building surface product as otherwise described herein, the gypsum body includes at least 1% by weight of reinforcing fibers. For example, in some embodiments, the gypsum body includes glass fibers. Further, in some embodiments, the gypsum panel includes cellulose-based fibers. Moreover, in some embodiments, the gypsum panel includes polyethylene, polypropylene or polyester fibers. Various embodiments of the building surface product include different combinations of the aforementioned fibers in the gypsum panel.

In some embodiments, the gypsum body includes one or more additives, such as biocides, hydrophobic additives, and fire resistance additives.

In certain embodiments of the building surface product as otherwise described herein, the panel is rectangular. For example, as shown in FIGS. 1A-1C, the shape of building surface product 100 is governed by panel 110, which has a rectangular form. In particular, a front edge along first side 114 runs parallel to the front edge along second side 115 and the two edges run across the width of panel 110. Likewise, the front edge along first end 116 is parallel to the front edge along second end 117. Moreover, the sides and ends of panel 110 are perpendicular to one another such that the shape of panel 110 is that of a rectangle. In other embodiments, the building surface product has another shape. For example, in some embodiments, the building surface product includes a panel having a different rectangular shape (including a square shape). Further, in some embodiments, the panel is formed as a trapezoid, triangle, square, parallelogram, hexagon, or other polygon.

In some embodiments, the building surface product is configured to form a wall surface or ceiling surface. For example, panel 110 of building surface product 100 is a wall panel. In other embodiments, the building surface product is configured to form a trim or decorative element. For example, in some embodiments, the panel of the building surface product is formed as a trim or decorative component that is attached to a support structure using the attachment posts of the disclosure. For example, in some embodiments the panel is a molding component, such as crown molding at the top of the building surface. In other embodiments, the panel forms a baseboard at the bottom of a building surface. Still in other embodiments, the panel forms corner trim or window trim. Various shapes for such trim configurations are possible. For example, in some embodiments, the trim may be flat, angled, or curved. Likewise, such trim can be proud, flush, or recessed. Still, in other embodiments the building surface product forms a decorative beam. In some embodiments, the building surface product passes over the middle of a building surface. For example, in some embodiments, the panel of the building surface product forms a chair rail, a batten or has another configuration that passes over the middle of the surface. In some embodiments, the building surface product includes a panel configured as a trim or decorative element and is formed of a polymer or wood and the first attachment post extends only partially through the panel.

In certain embodiments of the building surface product as otherwise described herein, the building surface product further includes a facing sheet that lines the gypsum body along at least one of the front surface and the rear surface. In some embodiments, the facing sheet is a paper facing. In other embodiments, the facing sheet includes reinforcing fibers. For example, in some embodiments, the facing sheet includes a fiberglass mat. Further, in some embodiments, the gypsum material is embedded into the facing sheet.

In certain embodiments of the building surface product as otherwise described herein, the facing sheet surrounds the panel along its length covering both the front surface and the rear surface. For example, in some embodiments, the facing sheet is formed from two distinct sheets that are wrapped around the gypsum panel. The facing sheets may then be attached to one another to surround the panel. In some embodiments, the facing sheets wrap around the panel along its length. The ends of the panel may then either be left uncovered or the facing sheets may also be folded over the ends. According to yet other embodiments, the facing sheets can also receive a treatment or coating prior to the installation of the product. Such treatments or coating may include a primer, a paint, a stain, a polymer, a film, or a lamination.

According to other embodiments described herein, a building surface system including a support structure, a first building surface product according to embodiments described herein attached to the support structure, and a second building surface product according to embodiments described herein attached to the support structure and adjacent to the first building surface product. The support structure may include a plurality of framing members that form a support surface. According to certain embodiments, the framing members may be formed of timber, such as wood studs. In other embodiments, the framing members are formed of metal, such as such as steel or aluminum studs. Other materials may also be used for the framing members.

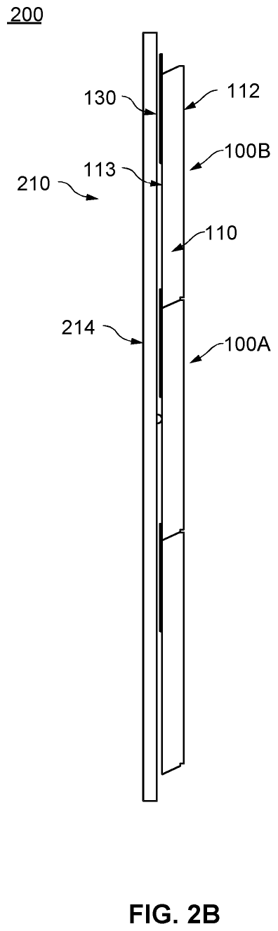

For purposes of illustration, a building surface system 200 is shown in FIG. 2A. Building surface system 200 includes a support structure 210 and a plurality of building surface products, including a first building surface product 100A and second building surface product 100B, attached to support structure 210. The support structure 210 includes a group of vertical framing members 214 arranged across the support structure to form a support surface. Each of the building surface products is secured to support structure 210 via the press-in fasteners described herein.

According to certain embodiments, the building surface system 200 described herein, the press-in fasteners of the first building surface product 100A attaches the rear surface of the panel of the first building surface product 100A to the support structure. For example, FIG. 2B shows a cross-sectional view of the connection of the first building surface product 100A to a framing member 214 of the support structure 210. As shown, the mending plate portion of the press-in fasteners may be secured to the rear surface 113 of the panel 110 of first building surface product 100A. Further, the support structure attachment portion of the press-in fasteners may be secured to framing member 214 with a mechanical fastener, such as a nail or a screw, which passes through a hanging hole of the support structure attachment portion of the press-in fasteners. According to yet other embodiments, the support structure attachment portion of the press-in fasteners may be secured to the framing member 214 with an adhesive. It will be appreciated that in situations where an adhesive is used to secure the press-in fasteners may be secured to the framing member 214, the support structure attachment portion would not require a hanging hole.

As noted herein, according to certain embodiments, the first building surface product 100A includes a top projection with an angled rear face and a bottom projection with an angled front face, and the second building surface product 100B includes a top projection with an angled rear face and a bottom projection with an angled front face. According to certain embodiments, when both building surface products 100A and 100B are attached to the support structure as described herein, the bottom projection with the angled front face of the building surface product 100B engages with the top projection with the angled rear face of the second building product 100A, such that the bottom of the building surface product 100B is held against the support structure by the top of the second building surface product 100A.

For purposes of embodiments described herein, the description of the angled front face of the first projection being secured against the angled rear face of the second projection includes a direct engagement of the respective angled front face and angled rear face, which ensures accurate positioning of the building surface products without the need for careful measuring or relying on the geometry of the vertical rail to set the spacing.

In another aspect, the disclosure provides a method of forming the building surface system according to the disclosure. The method includes positioning the first building surface product against the support structure, securing the first building surface product to the support structure, position the second building surface product against the support structure and adjacent to the first building surface product, and securing the second building surface product to the support structure. For example, as shown in FIG. 2A, each of the shown building surface products, such as first building surface product 100A and second building surface product 100B, is positioned against the support structure 210 and then secured in place.

In certain embodiments of the method as otherwise described herein, securing the first building surface product against the support structure includes attaching a tab of the first building surface product to a framing element of the support structure, where the press-in fastener is secured to the rear surface of the panel of the first building surface product. For example, as shown in FIG. 2B, the mending plate portion of the press-in fastener 130 is secured against the rear surface 113 of the panel 110 of the first building surface product 100A. The press-in fastener is then secured to the vertical framing member 214, for example, through the support structure attachment portion of the press-in fastener using a mechanical fastener, such as a wood screw or nail, which passes through the hole of the mending plate portion of the press-in fastener.

In certain embodiments of the method as otherwise described herein, positioning the second building surface product 100B includes placing a bottom projection of the second building surface product 100B behind a top projection of the first building surface product 100A. For example, the second building surface panel 100B is lowered onto the first building surface product 100A so that the bottom projection of the second building surface product 100B is placed behind the top projection of the first building surface product 100A. As a result, the angled front face of the second building surface product 100B is secured against the angled rear face of the first building surface product 100A, so that the first building surface product 100A assists in holding the second building surface product 100B against the support structure.

According to still other embodiments, a building surface product according to embodiments described herein may have a particular board center push-out strength. For purposes of embodiments described herein, board center push-out strength is defined as the pushout strength of a building surface product as measured using a Push-Out Strength test with the force being applied using a “board center” orientation (i.e., push-out pressure being applied to the center of the sample). The Push-Out Strength Test may be carried out using the following testing procedure: 1) provide a Test Sled, defined as a frame of standard 2×4 fir wood studding with two 18″ members mounted between two 22″ members with a 16″ on center spacing, 2) provide a Test Frame, defined as a testing frame constructed of T slot style aluminum extrusions sufficient to suspend the Test Sled on a gantry style compression test device such that the compressive force of the gantry lowering is applied to the rear of the shiplap sample, 3) prepare a Footer, defined as a shortened shiplap board that stops at the lower edge of the attachment plate and is used for sample indexing on the Test Sled, 4) prepare necessary Test Samples of the building surface product, defined as a 16″ wide section of the building surface product cut in the shiplap profile (with attachment plates mounted as close to the ends as possible where applicable), providing a 14″ on center spacing of the center attachment hole, 5) mount a Footer section shiplap on the lower end of the Test Sled, ensuring that at least 16″ remains above to mount Test Samples using a drywall screw (#6×1 in. #2 Phillips Bugle Head Coarse Thread Drywall Screw at minimum), ensure that the head of the screw is flush with the outward face of the attachment plate, and that the plate is not fastened tight enough to cause the face of the board to deflect outward, 6) mount two Test Samples above the footer in a similar fashion, ensuring a snug nesting of the lower board edge bevel against the upper board edge bevel of the previously installed Test Sample or Footer, determine the center line of the Test Samples and mark this line on the back side paper, 7) place Test Sled onto the Test Frame with Test Samples face down, 8) use the Test Machine's manual controls to move the upper platen (a 6″ circular disk) so that it is in contact with, but not applying pressure to the back side of the Test Samples, 9) adjust the positioning of the Test Frame to ensure that A) the platen is centered on the board if conducting a test in the “board center” orientation, or centered on the seam between the two Test Sample boards if conducting a test in the “seam center” orientation, and B) the platen is also centered on the centerline of the Test Sample width, (please note that this may not necessarily be in the center of the Test Sled, depending on initial footer placement), 10) initiate compression testing sequence with a speed of 5 mm/min, 11) cease testing sequence when measured force drops and rear facing paper of Test Samples has torn enough that most of the attachment plates have torn free of the gypsum, 12) test may be repeated re-using the same Footer to mount new Test Samples.

According to particular embodiments, the building surface product according to embodiments described herein may have a board center push-out strength of at least about 150 lbs, such as, at least about 155 lbs or at least about 160 lbs or at least about 165 lbs or at least about 170 lbs or at least about 175 lbs or at least about 180 lbs or even at least about 185 lbs. It will be appreciated that the building surface product may have a board center push-out strength within a range between any of the values noted above. It will be further appreciated that the building surface product may have a board center push-out strength of any value between any of the minimum and maximum values noted above.

According to still other embodiments, the building surface product according to embodiments described herein may have a board center push-out strength increase, where the board center push-out strength increase defined as the percent increase in the Push Out Strength of the building surface product over the average Push-Out Strength of a random sampling of statistically significant number of sample conventional building products as described herein using the “board center” testing orientation (i.e., Push-Out Strength Increase=100*(BSP_{POS}-CBPA_{POS})/CBPA_{POS}, where BSP_{POS} is the Push Out Strength of the building surface product, and CBPA_{POS} is the average Push-Out Strength of a random sampling of statistically significant number of conventional building product as described herein). For example, the building surface product according to embodiments described herein may have a board center push-out strength increase of at least about 5%, such as, at least about 8% or at least about 10% or at least about 13% or at least about 15% or at least about 18% or at least about 20% or even at least about 25%. It will be appreciated that the building surface product may have a board center push-out strength increase within a range between any of the values noted above. It will be further appreciated that the building surface product may have a board center push-out strength increase of any value between any of the minimum and maximum values noted above.

According to still other embodiments, the building surface product according to embodiments described herein may have a particular board beam push-out strength. For purposes of embodiments described herein, board beam push-out strength is defined as the pushout strength of a building surface product as measured using a Push-Out Strength test with the force being applied using a “board seam” orientation (i.e., to the center of one of the panels of the sample). The Push-Out Strength Test may be conducted as described herein.

According to particular embodiments, the building surface product according to embodiments described herein may have a board seam push-out strength of at least about 150 lbs, such as, at least about 151 lbs or at least about 152 lbs or at least about 153 lbs or at least about 154 lbs or at least about 155 lbs or at least about 156 lbs or even at least about 157 lbs. It will be appreciated that the building surface product may have a board seam push-out strength within a range between any of the values noted above. It will be further appreciated that the building surface product may have a board seam push-out strength of any value between any of the minimum and maximum values noted above.

According to still other embodiments, the building surface product according to embodiments described herein may have a board seam push-out strength increase, where the board seam push-out strength increase defined as the percent increase in the Push Out Strength of the building surface product over the average Push-Out Strength of a random sampling of statistically significant number of sample conventional building products as described herein using the “board seam” testing orientation (i.e., Push-Out Strength Increase=100*(SBP_{POS}-CBPA_{POS})/CBPA_{POS}, where SBP_{POS} is the Push Out Strength of the building surface product, and CBPA_{POS} is the average Push-Out Strength of a random sampling of statistically significant number of conventional building product as described herein). For example, the building surface product according to embodiments described herein may have a board seam push-out strength increase of at least about 0.5%, such as, at least about 1% or at least about 2% or at least about 3% or at least about 4% or at least about 5% or at least about 6% or even at least about 7%. It will be appreciated that the building surface product may have a board seam push-out strength increase within a range between any of the values noted above. It will be further appreciated that the building surface product may have a board seam push-out strength increase of any value between any of the minimum and maximum values noted above.

It will be apparent to those skilled in the art that various modifications and variations can be made to the processes and devices described here without departing from the scope of the disclosure. Thus, it is intended that the present disclosure cover such modifications and variations of this invention provided they come within the scope of the appended claims and their equivalents.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A building surface product comprising: a substantially planar panel having a front surface, a rear surface, a first side, a second side, a first end, a second end, a gypsum body between the front surface and the rear surface, and a first press-in fastener positioned on the rear surface of the substantially planar panel, the first press-in fastener comprising: a mending plate portion comprising a plurality of prongs inserted into the rear surface of the substantially planar panel, and a support structure attachment portion.

Embodiment 2. A building surface system comprising: a support structure including a plurality of framing members that form a support surface; a first building surface product, and a second building surface product, wherein the first building surface product comprises a substantially planar panel having a front surface, a rear surface, a first side, a second side, a first end, a second end, a gypsum body between the front surface and rear surface, and a first press-in fastener positioned on the rear surface of the substantially planar panel, the first press-in fastener comprising: a mending plate portion comprising a plurality of prongs inserted into the rear surface of the substantially planar panel, and a support structure attachment portion; and wherein the second building surface product comprises a substantially planar panel having a front surface, a rear surface, a first side, a second side, a first end, a second end, a gypsum body between the front surface and the rear surface, and a first press-in fastener positioned on the rear surface of the substantially planar panel, the first press-in fastener comprising: a mending plate portion comprising a plurality of prongs inserted into the rear surface of the substantially planar panel, and a support structure attachment portion.

Embodiment 3. A method of forming the building surface system according to embodiment 2, the method comprising: positioning the first building surface product against the support structure; securing the first building surface product to the support structure; position the second building surface product against the support structure and adjacent to the first building surface product; and securing the second building surface product to the support structure.

Embodiment 4. The building surface product, building surface system or method of any one of embodiments 1, 2, and 3, wherein the panel includes a first projection extending along the first side of the panel and positioned at the front surface of the panel, and a second projection extending along the second side of the panel and configured to fit behind a first projection of a neighboring panel.

Embodiment 5. The building surface product, building surface system or method of any one of embodiments 1, 2, and 3, wherein the first projection has an angled rear face, and the second projection has an angled front face.

Embodiment 6. The building surface product, building surface system or method of any one of embodiments 1, 2, and 3, wherein a portion of the panel that extends from a centerline of the panel to the second side of the panel is free of fasteners.

Embodiment 7. The building surface product, building surface system or method of any one of embodiments 1, 2, and 3, wherein the support structure attachment portion of the first press-in fastener extends upward from the mending plate portion of the first press-in fastener.

Embodiment 8. The building surface product, building surface system or method of any one of embodiments 1, 2, and 3, wherein the support structure attachment portion extends above an upper edge of the rear surface of the planar panel.

Embodiment 9. The building surface product, building surface system or method of any one of embodiments 1, 2, and 3, wherein the support structure attachment portion comprises a tab.

Embodiment 10. The building surface product, building surface system or method of any one of embodiments 1, 2, and 3, wherein the support structure attachment portion further comprises a hanging hole.

Embodiment 11. The building surface product, building surface system or method of embodiment 10, wherein the hanging hole is a counter sink hole.

Embodiment 12. The building surface product, building surface system or method of embodiment 10, wherein the support structure attachment portion further comprises a slot adjacent to the hanging hole.

Embodiment 13. The building surface product, building surface system or method of any one of embodiments 1, 2, and 3, wherein the support structure attachment portion further comprises an adhesive.

Embodiment 14. The building surface product, building surface system or method of embodiment 13, wherein the adhesive is configured to attach the support structure attachment portion to a structure.

Embodiment 15. The building surface product, building surface system or method of any one of embodiments 1, 2, and 3, wherein the mending plate portion of the first press-in fastener is covered by the rear surface of the planar panel.

Embodiment 16. The building surface product, building surface system or method of any one of embodiments 1, 2, and 3, wherein a width of the planar panel from the first side to the second side is at least 50 mm.

Embodiment 17. The building surface product, building surface system or method of any one of embodiments 1, 2, and 3, wherein a width of the planar panel from the first side to the second side is not greater than 3 meters.

Embodiment 18. The building surface product, building surface system or method of any one of embodiments 1, 2, and 3, wherein a length of the planar panel from the first end to the second end is at least 20 mm.

Embodiment 19. The building surface product, building surface system or method of any one of embodiments 1, 2, and 3, wherein a length of the panel from the first end to the second end is not greater than 7 meters.

Embodiment 20. The building surface product, building surface system or method of any one of embodiments 1, 2, and 3, wherein a thickness of the planar panel is at least 5 mm.

Embodiment 21. The building surface product, building surface system or method of any one of embodiments 1, 2, and 3, wherein a thickness of the panel is not greater than 100 mm.

Embodiment 22. The building surface product, building surface system or method of any one of embodiments 1, 2, and 3, wherein the gypsum body comprises a reinforced gypsum material.

Embodiment 23. The building surface product, building surface system or method of any one of embodiments 1, 2, and 3, wherein the gypsum body includes at least 1% by weight polymer.

Embodiment 24. The building surface product, building surface system or method of embodiment 23, wherein the polymer includes starch and/or polyvinyl acetate.

Embodiment 25. The building surface product, building surface system or method of any one of embodiments 1, 2, and 3, wherein the gypsum body includes at least 1% by weight of reinforcing fibers.

Embodiment 26. The building surface product, building surface system or method of any one of embodiments 1, 2, and 3, further comprising a facing sheet that lines the gypsum body along at least one of the front surface and the rear surface.

Embodiment 27. The building surface product, building surface system or method of embodiment 26, wherein the facing sheet is a paper facing.

Embodiment 28. The building surface system of embodiment 2, wherein the first press-in fastener of the first building surface product holds the first building surface product via the mending plate portion and is attached to the support structure via the support structure attachment portion.

Embodiment 29. The building surface system of embodiment 28, wherein the support structure attachment portion is attached to the support structure using a mechanical fastener.

Embodiment 30. The building surface system of embodiment 2, wherein the first building surface product includes a first projection that is positioned in front of a portion of the panel of the second building surface product so as to hold the panel of the second building surface product against the support structure.

Embodiment 31. The building surface system of embodiment 2, further comprising an aesthetic gap feature along the first side of the first building surface product and an edge along the second side of the second building surface product.

Embodiment 32. The method of embodiment 3, wherein securing the first building surface product against the support structure includes attaching the support structure attachment portion of the first press-in fastener of the first building surface product to a framing element of the support structure.

Embodiment 33. The method of embodiment 28, wherein positioning the second building surface product includes placing a second projection of the second building surface product behind a first projection of the first building surface product.

Embodiment 34. The method of embodiment 28, further comprising an aesthetic gap feature along an edge along the first side of the first building surface product and an edge along the second side of the second building surface product.

Embodiment 35. The method of embodiment 34, wherein the aesthetic gap feature is filled with a functional material or a functional component.

Embodiment 36. The building surface product, building surface system or method of any one of embodiments 1, 2, and 3, wherein the building surface product has a board center push-out strength of at least about 150 lbs.

Embodiment 37. The building surface product, building surface system or method of any one of embodiments 1, 2, and 3, wherein the building surface product has a board seam push-out strength of at least about 150 lbs.

Embodiment 38. The building surface product, building surface system or method of any one of embodiments 1, 2, and 3, wherein the building surface product has a board center push-out strength increase of at least about 5%.

Embodiment 39. The building surface product, building surface system or method of any one of embodiments 1, 2, and 3, wherein the building surface product has a board seam push-out strength increase of at least about 1%.

### EXAMPLES

### Example 1

The following non-limiting examples illustrate embodiments described herein.

Push-out strength performance of a building product (“sample building product”) constructed according to embodiments described herein (i.e. a panel-based building surface product attached to a frame using a press-in fastener as shown in FIG. 1E) was compared to push-out strength performance of a conventional building product (i.e. conventional gypsum board attached to a frame using conventional attachment means). Multiple samples of each sample building product and each conventional building product were evaluated to determine their performance in a Push-Out Strength test conducted as described herein.

For the conventional building product, push-out strength performance was evaluated by applying pressure using a “board center” orientation (i.e., push-out pressure being applied to the center of the sample) according to the protocol of the Push-Out Strength test described herein. For the sample building product, push-out strength performance was evaluated by applying pressure using 1) a “board center” orientation (i.e. to the center of one of the panels of the sample) according to the protocol of the Push-Out Strength test described herein, and 2) a “board seam” orientation (i.e. to the seam between the two panels of the sample) according to the protocol of the Push-Out Strength test described herein.

The results of the Push-Out Strength test conducted on the conventional building product using the “board center” testing orientation are summarized in Table 1 below. The table includes the tested Push-Out Strength of each conventional building product.

TABLE 1
Push-Out Strength Test: Conventional Building Product
(“board center” orientation)

| Sample | Push-Out Strength (lbs.) |
|---|---|
| CS1 | 142.155 |
| CS2 | 151.658 |
| CS3 | 122.812 |
| CS4 | 158.636 |
| CS5 | 141.316 |
| CS6 | 144.962 |
| CS7 | 165.434 |
| Average | 146.710 |

The results of the Push-Out Strength test conducted on the sample building product using the “board center” testing orientation are summarized in Table 2 below. The table includes 1) the tested Push-Out Strength of each sample building product and 2) the Push-Out Strength Increase of each sample building product, where the Push-Out Strength Increase is defined as the percent increase in the Push Out Strength of the Sample Building Product over the average Push-Out Strength of a random sampling of statistically significant number of conventional building product as described herein using the “board center” testing orientation (i.e., Push-Out Strength Increase=100*(SBP_{POS}−CBPA_{POS})/CBPA_{POS}, where SBP_{POS} is the Push Out Strength of the Sample Building Product, and CBPA_{POS} is the average Push-Out Strength of a random sampling of statistically significant number of conventional building product as described herein).

TABLE 2
Push-Out Strength Test: Sample Building Product
(“board center” orientation)

| | | Push-Out Strength |
|---|---|---|
| Sample | Push-Out Strength (lbs.) | Increase (%) |
| S1 | 188.385 | 28.41 |
| S2 | 181.854 | 24.00 |
| Average | 185.120 | 26.19 |

The results of the Push-Out Strength test conducted on the sample building product using the “board seam” testing orientation are summarized in Table 3 below. The table includes 1) the tested Push-Out Strength of each sample building product and 2) the Push-Out Strength Increase of each sample building product, where the Push-Out Strength Increase is defined as the percent increase in the Push Out Strength of the Sample Building Product over the average Push-Out Strength of a random sampling of statistically significant number of conventional building product as described herein using the “board center” testing orientation (i.e., Push-Out Strength Increase=100*(SBP_{POS}−CBPA_{POS})/CBPA_{POS}, where SBP_{POS} is the Push Out Strength of the Sample Building Product, and CBPA_{POS} is the average Push-Out Strength of a random sampling of statistically significant number of conventional building product as described herein).

TABLE 3
Push-Out Strength Test: Sample Building Product
(“board beam” orientation)

| | | Push-Out Strength |
|---|---|---|
| Sample | Push-Out Strength (lbs.) | Increase (%) |
| S3 | 147.241 | 0.36 |
| S4 | 189.226 | 28.98 |
| S5 | 127.018 | −13.42 |
| S6 | 160.533 | 9.42 |
| S7 | 167.92 | 14.46 |
| Average | 158.388 | 7.96 |

As can be seen from a comparison between push-out strength performance of the convention building product and the push-out strength performance of sample building product according to embodiments described herein, the sample building product showed improved push-out strength when tested in both a “board center” orientation and when tested in a “board seam” orientation as compared to the push-out strength performance of conventional products when tested in a “board center” orientation.

Note that not all of the activities described above in the general description, or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A building surface product comprising:
a substantially planar panel having a front surface, a rear surface, a first side, a second side, a first end, a second end, a gypsum body between the front surface and the rear surface, and
a first press-in fastener positioned on the rear surface of the substantially planar panel, the first press-in fastener comprising:
a mending plate portion comprising a plurality of prongs inserted into the rear surface of the substantially planar panel, and
a support structure attachment portion.

2. The building surface product of claim 1, wherein the panel includes a first projection extending along the first side of the panel and positioned at the front surface of the panel, and a second projection extending along the second side of the panel and configured to fit behind a first projection of a neighboring panel.

3. The building surface product of claim 1, wherein the first projection has an angled rear face, and the second projection has an angled front face.

4. The building surface product of claim 1, wherein a portion of the panel that extends from a centerline of the panel to the second side of the panel is free of fasteners.

5. The building surface product of claim 1, wherein the support structure attachment portion of the first press-in fastener extends upward from the mending plate portion of the first press-in fastener.

6. The building surface product of claim 1, wherein the support structure attachment portion extends above an upper edge of the rear surface of the planar panel.

7. The building surface product of claim 1, wherein the building surface product has a board center push-out strength of at least about 150 lbs.

8. The building surface product of claim 1, wherein the building surface product has a board seam push-out strength of at least about 150 lbs.

9. A building surface system comprising:
a support structure including a plurality of framing members that form a support surface,
a first building surface product, and
a second building surface product,
wherein the first building surface product comprises a substantially planar panel having a front surface, a rear surface, a first side, a second side, a first end, a second end, a gypsum body between the front surface and rear surface, and a first press-in fastener positioned on the rear surface of the substantially planar panel, the first press-in fastener comprising:
a mending plate portion comprising a plurality of prongs inserted into the rear surface of the substantially planar panel, and
a support structure attachment portion; and
wherein the second building surface product comprises a substantially planar panel having a front surface, a rear surface, a first side, a second side, a first end, a second end, a gypsum body between the front surface and the rear surface, and a first press-in fastener positioned on the rear surface of the substantially planar panel, the first press-in fastener comprising:
a mending plate portion comprising a plurality of prongs inserted into the rear surface of the substantially planar panel, and
a support structure attachment portion.

10. The building surface system of claim 9, wherein the panel includes a first projection extending along the first side of the panel and positioned at the front surface of the panel, and a second projection extending along the second side of the panel and configured to fit behind a first projection of a neighboring panel.

11. The building surface system of claim 9, wherein the first press-in fastener of the first building surface product holds the first building surface product via the mending plate portion and is attached to the support structure via the support structure attachment portion.

12. The building surface system of claim 9, wherein the support structure attachment portion is attached to the support structure using a mechanical fastener.

13. The building surface system of claim 9, wherein the first building surface product includes a first projection that is positioned in front of a portion of the panel of the second building surface product so as to hold the panel of the second building surface product against the support structure.

14. The building surface system of claim 9, wherein the building surface product has a board center push-out strength of at least about 150 lbs.

15. The building surface system of claim 9, wherein the building surface product has a board seam push-out strength of at least about 150 lbs.

16. A method of forming the building surface system according to claim 2, the method comprising:
positioning the first building surface product against the support structure,
securing the first building surface product to the support structure,
position the second building surface product against the support structure and adjacent to the first building surface product; and
securing the second building surface product to the support structure.

17. The method of claim 16, wherein securing the first building surface product against the support structure includes attaching the support structure attachment portion of the first press-in fastener of the first building surface product to a framing element of the support structure.

18. The method of claim 16, wherein positioning the second building surface product includes placing a second projection of the second building surface product behind a first projection of the first building surface product.

19. The method of claim 16, wherein the building surface product has a board center push-out strength of at least about 150 lbs.

20. The method of claim 16, wherein the building surface product has a board seam push-out strength of at least about 150 lbs.
